(19) United States
(12) Patent Application Publication
(10) Pub. No.: US 2007/0219090 A1
(43) Pub. Date: Sep. 20, 2007

(54) Supported gold catalysts

(76) Inventors: Michael Bowker, Sonning Common (GB); Jorge Manuel Caranelo Soares, Roath (GB)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/650,392

(22) Filed: Jan. 5, 2007

(30) Foreign Application Priority Data
Jul. 5, 2005 (GB) PCT/GB05/02645
Nov. 26, 2004 (GB) GB 0426066.7
Jul. 6, 2004 (GB) GB 0415111.4

(51) Int. Cl. B01J 23/04

(52) U.S. Cl. 502/344

(57) ABSTRACT

The invention provides a process for the production of a supported gold catalyst suitable for catalysing the oxidation of carbon monoxide to carbon dioxide. A porous support is impregnated with a solution of gold compound and with a basic solution, using an incipient wetness impregnation technique, such that gold hydroxide is precipitated in the pores of the support. The impregnation step is carried out using a compound comprising chloride. The chloride is then removed from the sample. Surprisingly, the catalyst formed by the process is effective in catalysing the oxidation of carbon monoxide to carbon dioxide at room temperature.

### RELATED APPLICATION DATA

This application corresponds to International (PCT) Patent Application No. PCT/GB2005/002645, filed Jul. 5, 2005, which published as WO 2006/003450 on Jan. 12, 2006; it claims priority from GB Patent Application No. 0426066.7, filed Nov. 26, 2004 and GB Patent Application No. 0415111.4, filed Jul. 6, 2004, both of which are incorporated herein in their entirety by reference thereto.

### BACKGROUND OF THE INVENTION

1. Field Of The Invention

The present invention relates to processes for the production of supported gold catalysts by incipient wetness impregnation methods, to catalysts obtainable by such processes, and to processes for the oxidation of carbon monoxide to carbon dioxide catalysed by such catalysts.

2. Description Of The Prior Art

In the past 20 years there has been an ever-expanding effort in the field of catalysis by gold, particularly since the reports of Haruta (M. Haruta et al, Chemistry Letters 1987, 405; M. Haruta et al, J. Catalysis 1993, 144, 175) and Hutchings (G. J. Hutchings et al, J. Chem. Soc. Chem. Commun. 1988, 71) on gold activity for certain reactions. From these first reports it was evident that the method of preparation of such catalysts was a crucial factor in determining the efficiency of these materials for, for example, the CO oxidation reaction.

It was shown that one of the best catalysts for the latter reaction was Au/TiO₂ and that this could successfully convert CO below ambient temperature (F. Schuth et al, Appl. Catalysis A: General 2002, 226, 1-13; M. Haruta, et al., Report of the research achievements of interdisciplinary basic research section (ONRI)—“The abilities and potential of Gold as a Catalyst” 1999) but such activity was only achieved when using the method of deposition-precipitation (DP). The deposition-precipitation method involves increasing the pH of a dilute slurry containing the support (e.g. TiO₂ P25), using ammonia or Na₂CO₃ to a pH>PZC of support (PZC=Point of Zero Charge). For TiO₂ P25, the PZC is 4-6 (M. Haruta et al, Preparation of Catalysts V, 1991, 695). At this point Au(OH)₃ is precipitated from solution onto the surface of the support.

In contrast, gold catalysts produced using the incipient wetness (IW) method were shown to have poor activity, only giving significant conversion at T>100° C. (M. Haruta, Catal. Surveys of Japan 1997, 1, 61; D. T. Thompson et al, Catal. Rev.—Sci. Eng. 1999, 41, 319). These incipient wetness techniques for producing gold catalysts involved impregnating a gold compound, usually chloroauric acid, in aqueous solution into the pores of the catalyst, with very little volume of liquid used, such that there is virtually no excess liquid.

The essential difference between the DP and IW methods is that in the former Au is deposited as the hydroxide and Cl largely remains in solution, whereas, in contrast, for IW catalysts, XRF and XPS studies have been used to show that the Cl remains in the catalyst and reaction correlations suggest that it is connected with their lower activity (M. A. Vannice et al, Catalysis Letters 1993 17, 245; S. Galvagno et al, Phys. Chem. Chem. Phys. 1999, 1, 2869; Y. Iwasawa et al, J. Catalysis 1997, 170, 191). Despite that, information on the role of chlorine is scarce.

### SUMMARY OF THE INVENTION

In the new method of IW preparation described, we aim to deposit gold hydroxide within the pores of the support, such as titania, and to remove any chloride from the sample.

Accordingly, the present invention provides a process for the production of a supported gold catalyst suitable for catalysing the oxidation of carbon monoxide to carbon dioxide, which comprises:
(a) impregnating a porous support with a solution of gold compound and with a basic solution, using an incipient wetness impregnation technique, such that gold hydroxide is precipitated in the pores of the support;
   wherein when step (a) involves the use of a compound comprising chloride, the process further comprises:
(b) removing chloride from the sample.

### BRIEF DESCRIPTION OF THE DRAWINGS

The invention will be more fully understood and further advantages will become apparent when reference is had to the following detailed description of the invention and the accompanying drawings, in which:

FIG. 1 is a graph showing XPS data for the Cl₂ₚ signal; and FIG. 2 is a graph showing reactor results for CO oxidation on the catalysts and for standard DP and IW samples.

### DETAILED DESCRIPTION OF THE INVENTION

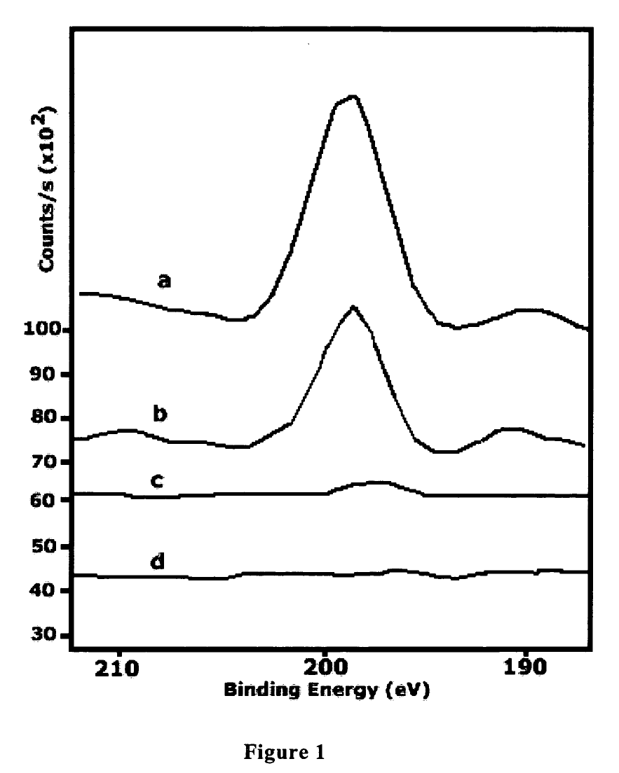

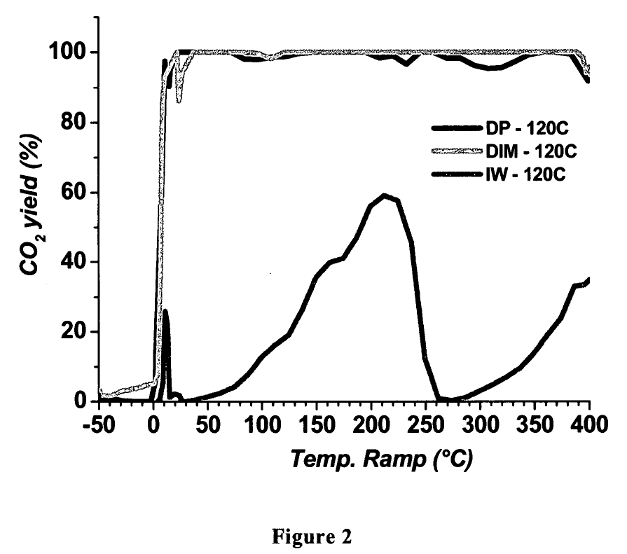

Referring to the drawings, FIG. 1 shows XPS data for the Cl₂p signal. Specifically, it shows XPS Cl₂ₚ Binding Energy for Au/TiO₂ catalysts, with a) showing 5 wt % Au/TiO₂ catalyst prepared by the IW method, pre-treatment at 120° C.; b) showing 5 wt % Au/TiO₂ catalyst prepared by the IW method, pre-treatment at 400° C.; c) showing 1.6 wt % Au/TiO₂ catalyst prepared by the DP method, pre-treatment 120° C.; and d) showing 1.6 wt % Au/TiO₂ catalyst prepared by the DP method, pre-treatment 400° C. This confirms high levels of Cl are present in the IW samples, whereas there is almost no Cl for the DP samples.

Cl probably results both in some poisoning of the active sites of the catalyst, but also in sintering of the Au nanoparticles. Small particle size is important for catalysing the reaction of carbon monoxide to carbon dioxide, and this is achieved for the DP catalysts, the usual size range being ˜2-8 nm (M. Haruta, et al., Report of the research achievements of interdisciplinary basic research section (ONRI)—“The abilities and potential of Gold as a Catalyst”. 1999; D. W. Goodman et al, Science 1998, 281, 1647). In contrast, IW catalysts can have small numbers of very large particles, often larger than 30 nm diameter (M. Haruta, CatTech. 2002, 6(3), 102).

It has now been identified that it is indeed possible, by appropriate preparation methodology, to make highly active Au catalysts by IW methods.

As is known in the art, an incipient wetness technique involves the amount of solution used for the impregnation being close to 100 percent (e.g. from 95 to 100%, preferably from 99 to 100%) of the absorptive capacity of the support material, such that the total volume of liquid used in the technique is just sufficient to fill the pores of the porous support to incipient wetness.

The solution of gold compound and the basic solution may be incipient wetness impregnated simultaneously or may, preferably, be incipient wetness impregnated sequentially in either order. Preferably, the solution of gold compound is impregnated first, followed by the basic solution.

The solution of gold compound may have any suitable solvent but is preferably an aqueous solution. The gold compound may be any suitable compound, such as chloroauric acid, alkali metal chloroaurates (e.g. sodium chloroaurate, potassium chloroaurate), gold acetate, gold chloride, and alkali metal aurates. Preferred gold compounds are those that can be provided in aqueous solution and particularly preferred compounds include chloroauric acid, sodium chloroaurate, potassium chloroaurate, and gold chloride. In a preferred embodiment the solution of gold compound is an aqueous solution of chloroauric acid.

The basic solution may be any suitable solution. Preferably, the basic solution is an aqueous solution, such as an aqueous solution of ammonia or an alkali metal salt, such as an alkali metal hydroxide, silicate, borate, carbonate or bicarbonate. The alkali metal is suitably sodium or potassium. The basic solution may, for example, suitably be an aqueous solution of sodium carbonate, potassium carbonate, sodium hydroxide or ammonia.

The porous support may be any suitable catalytic support, but preferably is an oxide, for example it may be selected from aluminophosphates, hexaluminates, aluminasilicates, alumina, silica, iron oxide, zirconates, titanosilicates, and titanates. More preferably, the support is a metal oxide, particularly a transition metal oxide, such as titanium dioxide or iron oxide. In a preferred embodiment, the porous support is titanium dioxide.

Preferably the porous support is in the form of a powder. It is preferred that the powder has a BET surface area of from 1 to 500 m²/g, which corresponds to particle sizes of from about 1000 nm down to about 2 nm. More preferably, the powder has a BET surface area of from 5 to 200 m²/g, most preferably from 10 to 100 m²/g, such as from 20 to 80 m²/g, for example from 40 to 60 m²/g.

The concentration of gold in the solution or solutions used is such that the amount of gold in the solution(s) impregnated is equal to the amount desired to be present in the pores of the support. Preferably, the concentration of gold in the solution or solutions used in step (a) enables the support to be incipient wetness impregnated with from 0.1 to 10.0 wt % of Au, based on the weight of the support, preferably from 0.25 to 5.0 wt %, more preferably from 0.5 to 3.0 wt %, most preferably from 0.75 to 2.0 wt %, such as from 0.9 to 1.5 wt %, for example about 1 wt %.

Preferably the process for producing the catalyst is such that substantially no catalytic metal other than gold is deposited in the pores of the support. The catalytic metal other than gold is preferably a precious metal other than gold. In particular, the catalytic metal other than gold is preferably a precious metal which itself strongly binds carbon monoxide at the operating temperature of the catalyst and/or a precious metal which forms an alloy with gold which strongly binds carbon monoxide at the operating temperature of the catalyst. By strongly binds is meant that the binding of carbon monoxide to the catalytic metal other than gold poisons the catalyst by rendering it inactive at the operating temperature of the catalyst. Accordingly, in a preferred embodiment, neither an alloy of gold with another catalytic metal nor another catalytic metal in any other form is deposited in the pores of the support, except at levels due simply to impurity. In particular, a catalytic metal other than gold may suitably only be present in the supported gold catalyst produced by the process at a level of 0.05 wt % or less, preferably 0.01 wt % or less, more preferably 0.005 wt % or less, most preferably 0.001 wt % or less, for example 0.0005 wt % or less.

Preferably the gold supported catalyst that is produced by the process of the present invention has 60% or more of the gold that is present in the form of gold hydroxide, more preferably 70% or more, most preferably 80% or more, such as 90% or more, for example 95% or more.

When step (a) involves the use of a compound comprising chloride, e.g. chloroauric acid, the process further comprises step (b) of removing chloride from the sample.

Step (b) preferably comprises one or more washing steps. For example, the sample may be washed one or more times with water or a salt solution. When a salt solution is used it is preferably a basic solution, such as those mentioned above in relation to step (a), for example an aqueous solution of sodium carbonate.

Preferably, the sample is washed one or more times with water and is washed one or more times with a salt solution. These washings may be in any order and washing with water may be alternated with washing with salt solution. In one embodiment the sample is firstly washed one or more times with water and then is washed one or more times with a basic aqueous salt solution.

The process may optionally comprise the step of:

(c) drying the sample.

Step (c) may include one or more drying steps, which may suitably be selected from: drying in air at ambient temperature, drying in air at elevated temperature, drying under gas flow at ambient temperature, drying under gas flow at elevated temperature and drying under vacuum. When drying is carried out at elevated temperature, any suitable temperature may be used; preferably the elevated temperature is 50° C. or higher, more preferably 80° C. or higher, such as from 90° C. to 150° C., for example from 100° C. to 120° C. When drying is carried out under gas flow, any suitable gas may be used, for example nitrogen.

The drying of step (c) may be carried out for any suitable length of time, preferably from one hour to 48 hours, more preferably from two hours to 24 hours, for example from 5 to 15 hours.

In one embodiment step (c) may involve both drying in air at ambient temperature and drying in air at elevated temperature, for example drying in air at ambient temperature and drying in air at from 100° C. to 120° C.

The process may optionally comprise the step of:

(d) calcining the sample.

Step (d) may suitably involve calcining the sample in air, such as calcining at from 300 to 600° C., for example about 400° C., in air. The calcining may be for any suitable length of time, such as one hour or more, for example about 2 hours. Alternatively, the process of the invention may not involve a calcination step.

The present invention also provides a supported gold catalyst suitable for catalysing the oxidation of carbon monoxide to carbon dioxide obtainable by the process of the invention.

The present invention also provides a process for oxidising carbon monoxide to carbon dioxide, which process comprises contacting carbon monoxide with an oxidant in the presence of a catalyst according to the invention.

The operating temperature of the catalyst according to the invention is preferably a low operating temperature; more preferably, it is a temperature of from −20° C. to 100° C.; most preferably, it is a temperature of from −20° to 40° C.; the temperature may, for example, be at around room temperature. Preferably the oxidising process according to the invention is carried out at the operating temperature of the catalyst according to the invention.

The oxidant may be any suitable oxidant, for example air or other gas mixtures containing oxygen, such as He/O₂ gas mixtures.

In one embodiment the process comprises:
(i) producing a catalyst by using a process in accordance with the first aspect; and
(ii) contacting carbon monoxide with an oxidant in the presence of said catalyst.

The present invention further provides the use of a catalyst according to the invention to catalyse the oxidation of carbon monoxide to carbon dioxide. In particular, the use may be in: car exhaust systems, fuel cells, gas sensing, chemical processing, or air purification/anti pollution systems.

Advantages of the approach of the present invention to preparing gold catalysts, include the avoidance of loss of Au in the preparation method, in contrast to previous approaches which encountered this problem (D. T. Thompson et al, Catal. Rev.—Sci. Eng. 1999, 41, 319; C. Louis et al, J. Phys. Chem. B 2002, 106, 7634) and the improved effectiveness at catalysing CO to CO₂ oxidation as compared to conventional IW techniques. Further, since all the Au is precipitated in the pores before the washing procedure, the weight loading can be accurately determined without external analysis. Another advantage is the possibility of using reduced volumes of liquid (e.g. tanks of slurry) as compared to those that would be required for large-scale production of Au catalysts by the DP method.

The invention will now be illustrated by reference to the following Example which is not intended to limit the scope of the invention claimed.

### EXAMPLE

A supported gold catalyst was produced by depositing gold hydroxide within the pores of the titania support, and removing chloride from the sample. This was achieved by using a double impregnation method (DIM) of incipient wetness impregnation as follows.

5 g of Degussa P25 titania, (BET surface area of 50 m²/g; particle size of about 20 nm) was impregnated with 1.25 ml of 0.08 g/ml HAuCl₄.3H₂O solution while gently stirring the powder. 1.43 ml of Na₂CO₃ 1M solution was then added while continuing stirring the paste. This volume of liquid used is just sufficient to fill the pores of the powder to incipient wetness.

The mixture was then washed on a vacuum filter with 14 ml of the sodium carbonate solution in 100 ml of water and this was repeated five times, followed by five washings with 100 ml of water. The paste was left to dry overnight in air at ambient temperature and was further dried at 120° C. in air for 2 hours. The samples (A) were used directly in this form.

The amount of gold added in the catalyst preparation was equivalent to 1% by weight of Au.

FIG. 2 shows reactor results for CO oxidation on these catalysts and for standard DP and IW samples, for temperature programmed reaction with pulsing CO in 10% O₂/He flow. The details of the methodology for carrying out these rate measurements are as given in J. M. C. Soares et al, J. Catalysis 2003, 219, 17. The samples (A) had been dried at 120° C. in air for 2 h.

For the dried samples (A), FIG. 2 clearly shows the poor activity of the IW catalysts which only begins converting CO at ˜300° C. Two stages of CO₂ production can also be observed at lower temperatures (between 100-250° C.), but as reported in J. M. C. Soares et al, J. Catalysis 2003, 219, 17, these are non-catalytic (shows no oxygen consumption). True activity for that sample only begins at ˜300° C.

In contrast, the standard DP catalyst gives 100% conversion at ˜7° C., whilst the catalyst produced by the DIM method in accordance with the present invention is as good as the DP material.

It is believed that the main reason for the enhanced activity of the product of the present invention is that the production method was aimed to deposit the Au on the pores of the titania as Au(OH)₃, not as gold chloride which is what usually forms in the IW method. As a result the Cl is either left in solution, or is not associated with the Au, and can be removed from the catalyst by washing. In this way, after heating, it is possible to obtain the kind of small nanoparticles which interact well with the support, which are reported in literature (D. T. Thompson et al, Gold Bulletin 2000, 33(2), 41.) to be essential for high area, high concentration of interfacial sites and activity. In contrast, conventional IW catalysts are simply dried without washing, therefore they probably have highly chlorided gold species, as is evident from the XPS above, which are prone to sintering upon calcination. Additionally the chlorine may poison reaction sites at the support.

Variations may be made to the DIM catalyst described in this example in order to optimise desired properties. For instance, the weight loading of Au which has been used here may be varied, and catalysts may be made with other routes to raise the pH in the pores (e.g. ammonia solution), and catalysts may equally be produced with other oxidic supports, such as Fe₂O₃.

1. A process for the production of a supported gold catalyst suitable for catalysing the oxidation of carbon monoxide to carbon dioxide, which comprises:
(a) impregnating a porous support with a solution of gold compound and with a basic solution, using an incipient wetness impregnation technique, such that gold hydroxide is precipitated in the pores of the support;
wherein when step (a) involves the use of a compound comprising chloride, the process further comprises:
(b) removing chloride from the sample.

2. A process according to claim 1 wherein in step (a) the solution of gold compound is impregnated first, followed by the basic solution.

3. A process according to claim 1 wherein the solution of gold compound is an aqueous solution.

4. A process according to claim 1 wherein the gold compound is selected from: chloroauric acid, alkali metal chloroaurates, gold acetate, gold chloride, and alkali metal aurates.

5. A process according to claim 4 wherein the gold compound is chloroauric acid.

6. A process according to claim 1 wherein the basic solution is an aqueous solution of ammonia or alkali metal salt.

7. A process according to claim 6 wherein the basic solution is an aqueous solution of sodium carbonate, potassium carbonate, sodium hydroxide or ammonia.

8. A process according to claim 1 wherein the porous support is selected from aluminophosphates, hexaluminates, aluminasilicates, alumina, silica, iron oxide, zirconates, titanosilicates, and titanates.

9. A process according to claim 8 wherein the porous support is titanium dioxide.

10. A process according to claim 1 wherein the porous support is in the form of a powder.

11. A process according to claim 10 wherein the powder has a BET surface area of from 1 to 500 m²/g.

12. A process according to claim 1 wherein the concentration of gold in the solution or solutions used in step (a) enables the support to be incipient wetness impregnated with from 0.1 to 10.0 wt % of Au, based on the weight of the support.

13. A process according to claim 12 wherein the concentration of gold in the solution or solutions used in step (a) enables the support to be incipient wetness impregnated with from 0.5 to 3.0 wt % Au.

14. A process according to claim 1 wherein substantially no catalytic metals other than gold are deposited in the pores of the support.

15. A process according to claim 14 wherein the catalytic metal other than gold is a precious metal which itself strongly binds carbon monoxide at the operating temperature of the catalyst and/or a precious metal which forms an alloy with gold which strongly binds carbon monoxide at the operating temperature of the catalyst.

16. A process according to claim 14 wherein catalytic metals other than gold are present in the produced catalyst at a level of 0.05 wt % or less.

17. A process according to claim 16 wherein catalytic metals other than gold are present in the produced catalyst at a level of 0.005 wt % or less.

18. A process according to claim 1 wherein the gold supported catalyst that is produced by the process has 60% or more of the gold that is present in the form of gold hydroxide.

19. A process according to claim 18 wherein the gold supported catalyst that is produced by the process has 70% or more of the gold that is present in the form of gold hydroxide.

20. A process according to claim 1 wherein step (b) is carried out and comprises one or more washing steps.

21. A process according to claim 1 wherein the process comprises the step of:
(c) drying the sample.

22. A process according to claim 21 wherein step (c) includes one or more drying steps selected from: drying in air at ambient temperature, drying in air at elevated temperature, drying under gas flow at ambient temperature, drying under gas flow at elevated temperature and drying under vacuum.

23. A supported gold catalyst suitable for catalysing the oxidation of carbon monoxide to carbon dioxide obtainable by a process in accordance with claim 1.

24. A process for oxidising carbon monoxide to carbon dioxide, which process comprises contacting carbon monoxide with an oxidant in the presence of a catalyst in accordance with claim 25.

25. A process according to claim 24 which is carried out a temperature of from −20° to 100° C.

26. A catalytic oxidation process which comprises:
(i) producing a catalyst by using a process in accordance with claim 1; and
(ii) oxidising carbon monoxide by using a process according to claim 24.

27. A process according to claim 24, wherein the use process is carried out in a car exhaust systems, fuel cells, gas sensing, chemical processing, or air purification/anti pollution systems.
